(19) United States
(12) Patent Application Publication
(10) Pub. No.: US 2012/0154298 A1
(43) Pub. Date: Jun. 21, 2012

(54) Method for Adjusting Touch Positions of Software Keyboard, Non-Transitory Computer Readable Storage Medium for Storing Thereof and Touch Screen Electrical Device Applying Thereof

(75) Inventors: Cheng-Han Wu, Taipei City (TW); Chung-Wen Liao, New Taipei (TW); Wen-Tang Chen, Taoyuan City (TW); Chao-Chi Yang, Changhua City (TW)

(73) Assignee: INSTITUTE FOR INFORMATION INDUSTRY, Taipei (TW)

(21) Appl. No.: 13/079,111

(22) Filed: Apr. 4, 2011

(30) Foreign Application Priority Data
Dec. 15, 2010 (TW) 99144008

(51) Int. Cl. G06F 3/041

(52) U.S. Cl. 345/173

(57) ABSTRACT

A method for adjusting touch positions of software keyboard includes the following steps: a software keyboard is displayed on the touch screen. The preset characters are displayed respectively to receive at least one first touched position corresponding to each of the preset characters on the touch screen. A touched offset corresponding to each of the preset characters is calculated according to the at least one first touched position corresponding to each of the preset characters respectively. At least one touched boundary among each of the preset characters and the neighboring characters thereof is calculated according to the touched offset and the preset base center point corresponding to each of the preset characters respectively. A preset close-loop scope corresponding to each of the preset characters is calculated according to the touched boundaries respectively. Output characters according to the close-loop scopes touched.

### RELATED APPLICATIONS

This application claims priority to Taiwan Application Serial Number 099144008, filed Dec. 15, 2010, which is herein incorporated by reference.

### BACKGROUND

1. Technical Field

The present invention relates to a method for adjusting a touch screen, a non-transitory computer readable storage medium for storing thereof and a touch screen electrical device applying thereof. More particularly, the present invention relates to a method for adjusting touch positions of software keyboard, a non-transitory computer readable storage medium for storing thereof and a touch screen electrical device applying thereof.

2. Description of Related Art

As touch screens develop, touch screens are often taken as display units and input units for electrical devices. Wherein, most touch screen devices provide handwriting recognition input, external hardware keyboard input or software keyboard input.

Wherein, software keyboards are often provided as input devices for electrical devices without physical keyboard. Electrical devices display software keyboards, and users can touch displayed keys corresponding to characters for input. Since humans' fingers can't touch precisely at one point, which may cause error recognition for software keyboard input. Besides, software keyboards can't provide physical response when displayed keys of software keyboard are pressed, it's hard for users to determine if they press the right key. In particular, since capacitive touch screens can't sense a precise single point touched by humans' fingers, capacitive touch screens often recognize wrong input characters.

### SUMMARY

According to one embodiment of this invention, a method for adjusting touch positions of software keyboard is provided. The method for adjusting touch positions of software keyboard applies to an electrical device with a touch screen. In the method for adjusting touch positions of software keyboard, a touched boundary between each of the characters and the neighboring characters thereof are calculated according to touched positions for input. A close-loop scope corresponding to each of the characters is calculated according to the touched boundary. The character corresponding to the touched close-loop scope is output. The method for adjusting touch positions of software keyboard may take the form of a computer program product stored on a non-transitory computer-readable storage medium having computer-readable instructions embodied in the medium. The method for adjusting touch positions of software keyboard includes the following steps: a software keyboard is displayed on the touch screen. The software keyboard includes several keys. Several displayed boundaries are displayed among the keys. Each of the keys corresponds to a preset character respectively. Each of the preset characters corresponds to a preset base center point on the touch screen respectively. The preset characters are displayed respectively to receive at least one first touched position corresponding to each of the preset characters on the touch screen. A touched offset corresponding to each of the preset characters is calculated according to the at least one first touched position corresponding to each of the preset characters respectively. At least one touched boundary among each of the preset characters and the neighboring characters thereof is calculated according to the touched offset and the preset base center point corresponding to each of the preset characters respectively. A preset close-loop scope corresponding to each of the preset characters is calculated according to the touched boundaries respectively. A second touched position on the touch screen is received. A corresponding character, whose corresponding close-loop scope is occupied by the second touched position, is identified. Wherein, the corresponding close-loop scope is one of the preset close-loop scopes. The corresponding character is output.

According to another embodiment of this invention, a touch screen electrical device is provided. The touch screen electrical device calculates a touched boundary between each of the characters and the neighboring characters thereof according to touched positions for input. The touch screen electrical device calculates a close-loop scope corresponding to each of the characters according to the touched boundary. The touch screen electrical device outputs the character corresponding to the touched close-loop scope. The touch screen electrical device includes a touch screen, a storage unit and a processing unit. The processing unit is electrically connected to the touch screen and the storage unit. The touch screen displays a software keyboard. Wherein, the software keyboard includes several keys. Several displayed boundaries are displayed among the keys. The storage unit stores a preset character corresponding to each of the keys respectively and stores a preset base center point on the touch screen corresponding to each of the preset characters respectively. The processing unit includes a boundary setting module, an offset calculating module, a boundary calculating module, a curve calculating module and an output module. The boundary setting module displays the preset characters respectively to receive at least one first touched position corresponding to each of the preset characters on the touch screen. The offset calculating module calculates a touched offset corresponding to each of the preset characters according to the at least one first touched position corresponding to each of the preset characters respectively. The boundary calculating module calculates at least one touched boundary among each of the preset characters and the neighboring characters thereof according to the touched offset and the preset base center point corresponding to each of the preset characters respectively. The curve calculating module calculates a preset close-loop scope corresponding to each of the preset characters according to the touched boundaries respectively. The output module identifies and outputs a corresponding character, whose corresponding close-loop scope is occupied by the second touched position, when a second touched position on the touch screen is received. Wherein, the corresponding close-loop scope is one of the preset close-loop scopes.

Above all, since the distance between the preset base center point and the corresponding preset close-loop scope is closer, trustworthy can be provided for touch input. Besides, the touch screen displays the same software keyboard after the touch boundaries (the preset close-loop scopes) calculated, which can avoid that users touch different position for character input as the displayed software keyboard changes.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a flow diagram of a method for adjusting touch positions of software keyboard according to one embodiment of this invention;

FIG. 2A illustrates an embodiment of a touch screen 300;

FIG. 2B illustrates an embodiment of touched positions of the touch screen 300; and

FIG. 3 illustrates a block diagram of a touch screen electrical device according to another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

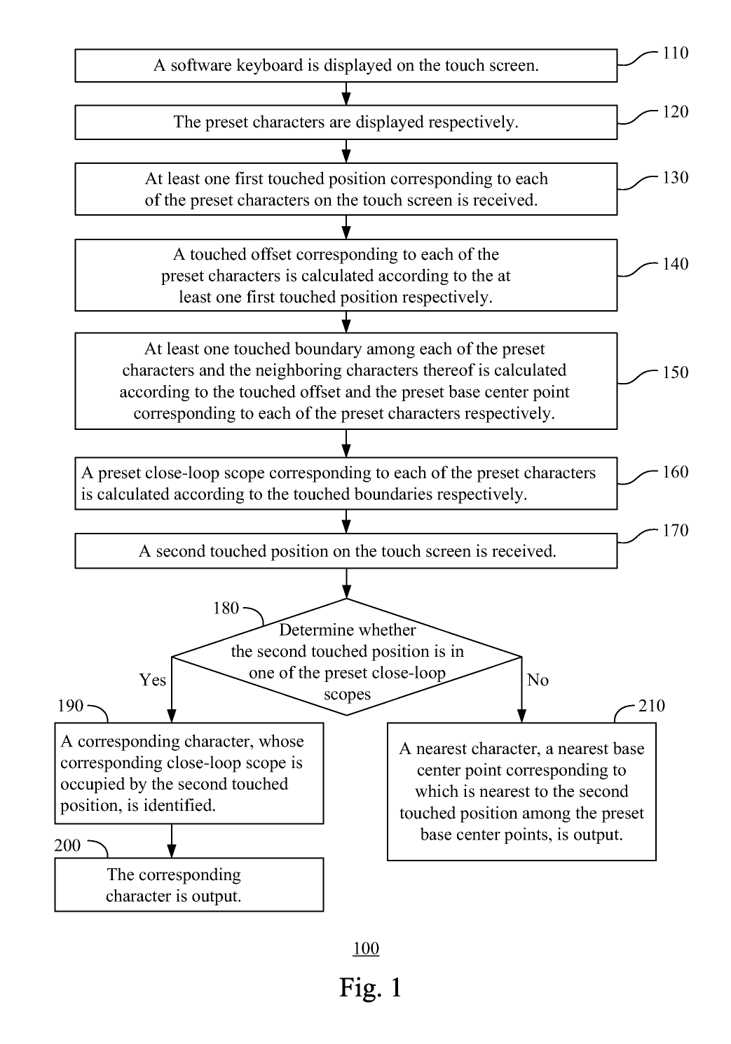

FIG. 1 is a flow diagram of a method for adjusting touch positions of software keyboard according to one embodiment of this invention. The method for adjusting touch positions of software keyboard applies to an electrical device with a touch screen. In the method for adjusting touch positions of software keyboard, a touched boundary between each of the characters and the neighboring characters thereof are calculated according to touched positions for input. A close-loop scope corresponding to each of the characters is calculated according to the touched boundary. The character corresponding to the touched close-loop scope is output. The method for adjusting touch positions of software keyboard may take the form of a computer program product stored on a non-transitory computer-readable storage medium having computer-readable instructions embodied in the medium. Any suitable non-transitory storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

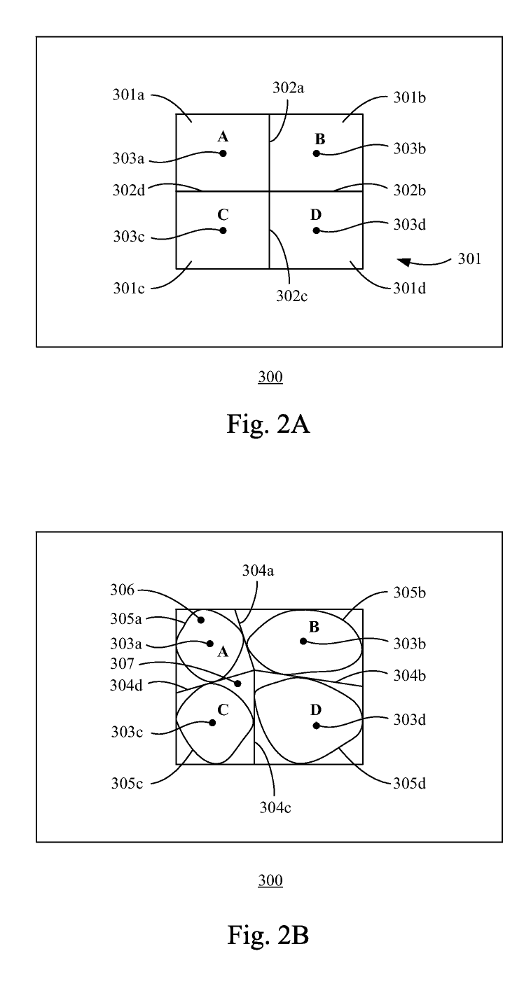

FIG. 2A illustrates an embodiment of a touch screen 300. Refer to both FIG. 1 and FIG. 2A. The method for adjusting touch positions of software keyboard 100 includes the following steps:

In step 110, a software keyboard 301 is displayed on the touch screen 300. The software keyboard 301 includes several keys 301a, 301b, 301c, 301d. Several displayed boundaries 302a, 302b, 302c, 302d are displayed among the keys 301a, 301b, 301c, 301d. Each of the keys 301a, 301b, 301c, 301d corresponds to a preset character “A”, “B”, “C”, “D” respectively. In other embodiments, the software keyboard may be designed differently for different languages or different purposes, which should not be limited in this disclosure. Each of the preset characters “A”, “B”, “C”, “D” corresponds to a preset base center point 303a, 303b, 303c, 303d on the touch screen 300 respectively. The preset base center point 303a, 303b, 303c, 303d is positioned inside the corresponding keys 301a, 301b, 301c, 301d.

In step 120, the preset characters “A”, “B”, “C”, “D” are displayed respectively to receive at least one first touched position corresponding to each of the preset characters on the touch screen (step 130). For example, “A” may be displayed (step 120) to make a user touch the key 301a on the touch screen 300. Then, at least one first touched position, which is touched by the user, corresponding to the preset character “A” on the touch screen may be received (step 130).

In step 140, a touched offset corresponding to each of the preset characters “A”, “B”, “C”, “D” is calculated according to the at least one first touched position corresponding to each of the preset characters “A”, “B”, “C”, “D” respectively. Wherein, the touched offset corresponding to each of the preset characters “A”, “B”, “C”, “D” is the distance from the first touched position to the corresponding preset base center point. Besides, to avoid mis-touched position to be taken as the first touched position, the method 100 may determine whether there is at least one deviated touched position, distance from which to the corresponding preset base center point is more than an offset limit, among the at least one first touched position corresponding to each of the preset characters “A”, “B”, “C”, “D”. If there is the at least one deviated touched position, the deviated touched position is removed before calculating the touched offset (step 140).

FIG. 2B illustrates an embodiment of touched positions of the touch screen 300. Refer to both FIG. 1 and FIG. 2B. In step 150, at least one touched boundary 304a, 304b, 304c, 304d among each of the preset characters “A”, “B”, “C”, “D” and the neighboring characters thereof is calculated according to the touched offset and the preset base center point 303a, 303b, 303c, 303d corresponding to each of the preset characters “A”, “B”, “C”, “D” respectively.

In step 160, a preset close-loop scope 305a, 305b, 305c, 305d corresponding to each of the preset characters “A”, “B”, “C”, “D” is calculated according to the touched boundaries 304a, 304b, 304c, 304d respectively. Wherein, the preset close-loop scopes 305a, 305b, 305c, 305d are taken as the touched scope corresponding to the preset characters “A”, “B”, “C”, “D” respectively. Each of the preset close-loop scopes 305a, 305b, 305c, 305d corresponding to each of the preset characters “A”, “B”, “C”, “D” includes several curves, and each of the curves thereof touches at least one of the touched boundaries 304a, 304b, 304c, 304d at just one point. The curves thereof may be Bazier Curves or other types of curves, which touch the corresponding touched boundaries 304a, 304b, 304c, 304d at just one point.

Then, the touched area corresponding to the preset characters “A”, “B”, “C”, “D” are set after step 110-160. Besides, the touch screen 300 displays the same software keyboard 301 as shown in FIG. 2A, which can avoid that users touch different position for character input as the displayed software keyboard 301 changes. Besides, the distance between the preset base center point 303a, 303b, 303c, 303d and the corresponding preset close-loop scope 305a, 305b, 305c, 305d is closer than the distance between the preset base center point 303a, 303b, 303c, 303d and the corresponding touched boundaries 304a, 304b, 304c, 304d, which can provide more trustworthy for touch input.

After step 110-160, users can touch the displayed software keyboard 301 on the touch screen 300 for input. Hence, in step 170, a second touched position on the touch screen is received.

In step 190, a corresponding character, whose corresponding close-loop scope is occupied by the second touched position, is identified. Wherein, the corresponding close-loop scope is one of the preset close-loop scopes 305a, 305b, 305c, 305d corresponding to the preset characters “A”, “B”, “C”, “D”.

In step 200, the corresponding character is output.

In one embodiment of this invention, if a second touch position 306 is received from the touch screen 300 (step 170), a corresponding character “A”, the second touched position 306 is in the close-loop scope 305a corresponding to which, is identified, and the corresponding character “A” is output (step 190).

Besides, if the second touched position is not in any of the preset close-loop scopes 305a, 305b, 305c, 305d, a nearest character, a nearest base center point corresponding to which is nearest to the second touched position among the preset base center points 303a, 303b, 303c, 303d, is output. Hence, in step 180, determine whether the second touched position is in one of the preset close-loop scopes 305a, 305b, 305c, 305d or not. If the second touched position is in one of the preset close-loop scopes 305a, 305b, 305c, 305d, the corresponding character is output utilizing step 190-200. In step 210, if the second touched position is not in one of the preset close-loop scopes 305a, 305b, 305c, 305d, a nearest character, a nearest base center point corresponding to which is nearest to the second touched position among the preset base center points, is output. For example, if a second touched position 307 is received from the touch screen 300, the nearest character “A”, a nearest base center point 303a corresponding to which is nearest to the second touched position 307 among the preset base center points 303a, 303b, 303c, 303d, is output. Hence, if the touched position is not positioned in any of the preset close-loop scopes 305a, 305b, 305c, 305d, corresponding characters can still be output.

Besides, offset along different axis (such as x-axis, y-axis, z-axis or other types of axes) can be taken into consideration for calculating more precisely touched boundaries. Hence, at least one first-axis distance from the preset base center point 303a, 303b, 303c, 303d to the at least one first touched position corresponding to each of the preset characters “A”, “B”, “C”, “D” along the first axis may be calculated respectively. Then, average of the at least one first-axis distance is calculated to be taken as the first axis offset corresponding to each of the preset characters “A”, “B”, “C”, “D” respectively. Besides, if the at least one first-axis distance is less than a threshold, the at least one first-axis distance can be assigned to zero to reduce the value of the first axis offset. A first deviated boundary is calculated according to the first axis offset and the preset base center point 303a, 303b, 303c, 303d corresponding to each of the preset characters “A”, “B”, “C”, “D”. Wherein, the first deviated boundary may be taken as the at least one touched boundary between each of the preset characters “A”, “B”, “C”, “D” and the neighboring characters thereof. In one embodiment of this invention, the first axis offset can be added to value of the preset base center point 303a, 303b, 303c, 303d along the first axis corresponding to each of the preset characters “A”, “B”, “C”, “D” to be taken as a first deviated center point corresponding to each of the preset characters “A”, “B”, “C”, “D”. Then, a first median, which is taken as the first deviated boundary, between each of the first deviated center point corresponding to each of the preset characters “A”, “B”, “C”, “D” and the first deviated center point corresponding to the neighboring characters thereof, is calculated.

Besides, at least one second-axis distance from the preset base center point 303a, 303b, 303c, 303d to the at least one first touched position corresponding to each of the preset characters “A”, “B”, “C”, “D” along the second axis may be calculated respectively. Then, average of the at least one second-axis distance is calculated to be taken as the second axis offset corresponding to each of the preset characters “A”, “B”, “C”, “D” respectively. Besides, if the at least one second-axis distance is less than a threshold, the at least one second-axis distance can be assigned to zero to reduce the value of the second axis offset. A second deviated boundary is calculated according to the second axis offset and the preset base center point 303a, 303b, 303c, 303d corresponding to each of the preset characters “A”, “B”, “C”, “D”. Wherein, the second deviated boundary may be taken as the at least one touched boundary between each of the preset characters “A”, “B”, “C”, “D” and the neighboring characters thereof. In one embodiment of this invention, the second axis offset can be added to value of the preset base center point 303a, 303b, 303c, 303d along the second axis corresponding to each of the preset characters “A”, “B”, “C”, “D” to be taken as a second deviated center point corresponding to each of the preset characters “A”, “B”, “C”, “D”. A second median, which is taken as the second deviated boundary, between each of the second deviated center point corresponding to each of the preset characters “A”, “B”, “C”, “D” and the second deviated center point corresponding to the neighboring characters thereof is calculated. Then, the second median can be taken as the at least one touched boundary between each of the preset characters “A”, “B”, “C”, “D” and the neighboring characters thereof. Therefore, the first deviated boundary and the second deviated boundary can be taken as the touched boundary, which can reduce inaccuracy of the touched boundary calculated with a single deviated center point.

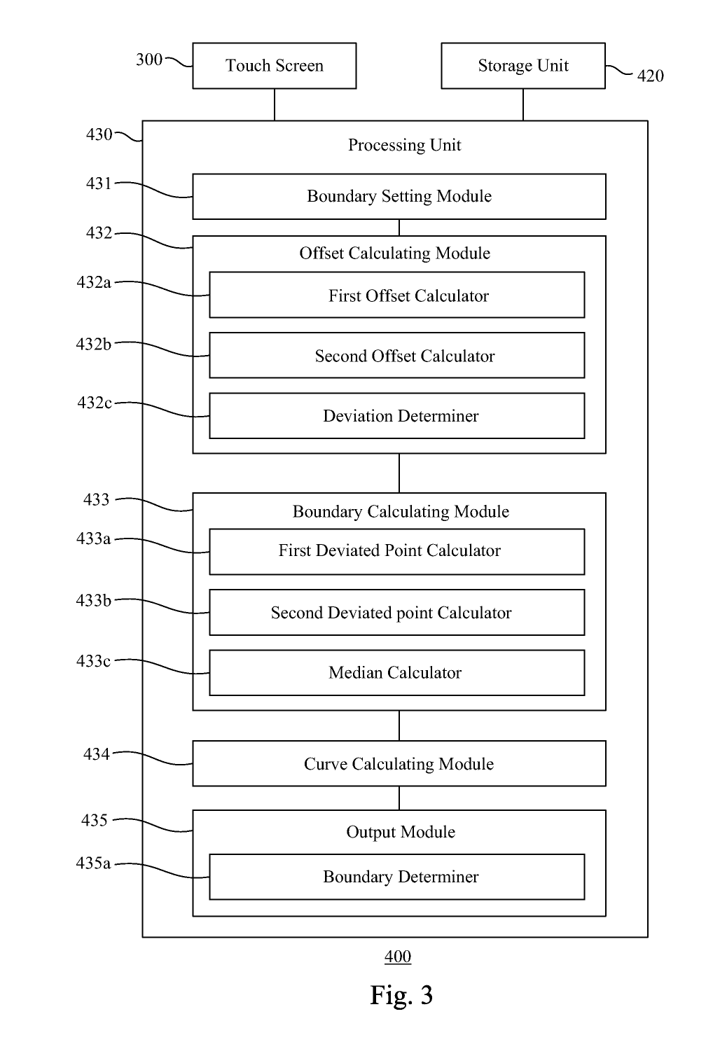

FIG. 3 illustrates a block diagram of a touch screen electrical device according to another embodiment of this invention. The touch screen electrical device calculates a touched boundary between each of the characters and the neighboring characters thereof according to touched positions for input. The touch screen electrical device calculates a close-loop scope corresponding to each of the characters according to the touched boundary. The touch screen electrical device outputs the character corresponding to the touched close-loop scope.

Refer to both FIG. 2A AND FIG. 3. The touch screen electrical device 400 includes a touch screen 300, a storage unit 420 and a processing unit 430. The processing unit 430 is electrically connected to the touch screen 300 and the storage unit 420. The touch screen 300 displays a software keyboard 301. Wherein, the software keyboard 301 includes several keys 301a, 301b, 301c, 301d. Several displayed boundaries 302a, 302b, 302c, 302d are displayed among the keys 301a, 301b, 301c, 301d. The storage unit 420 stores a preset character “A”, “B”, “C”, “D” corresponding to each of the keys respectively and stores a preset base center point 303a, 303b, 303c, 303d on the touch screen 300 corresponding to each of the preset characters “A”, “B”, “C”, “D” respectively. In other embodiments, the software keyboard may be designed differently for different languages or different purposes, which should not be limited in this disclosure.

The processing unit 430 includes a boundary setting module 431, an offset calculating module 432, a boundary calculating module 433, a curve calculating module 434 and an output module 435. The boundary setting module 431 makes the touch screen 300 display the preset characters “A”, “B”, “C”, “D” respectively to receive at least one first touched position corresponding to each of the preset characters “A”, “B”, “C”, “D” on the touch screen 300. For example, the boundary setting module 431 may make the touch screen 300 display the preset character “A” to make a user touch the key 301a on the touch screen 300. Then, at least one first touched position, which is touched by the user, corresponding to the preset character “A” on the touch screen may be received.

The offset calculating module 432 calculates a touched offset corresponding to each of the preset characters “A”, “B”, “C”, “D” according to the at least one first touched position corresponding to each of the preset characters “A”, “B”, “C”, “D” respectively. Wherein, the touched offset corresponding to each of the preset characters “A”, “B”, “C”, “D” is the distance from the first touched position to the corresponding preset base center point. Besides, to avoid mis-touched position to be taken as the first touched position, the offset calculating module may include a deviation determiner 432c. The deviation determiner 432c determines whether there is at least one deviated touched position, distance from which to the corresponding preset base center point 303a, 303b, 303c, 303d is more than an offset limit, among the at least one first touched position corresponding to each of the preset characters “A”, “B”, “C”, “D”. If there is the at least one deviated touched position, the offset calculating module 432 removes the deviated touched position before calculating the touched offset.

Refer to both FIG. 2B and FIG. 3. The boundary calculating module 433 calculates at least one touched boundary among each of the preset characters “A”, “B”, “C”, “D” and the neighboring characters thereof according to the touched offset and the preset base center point 303a, 303b, 303c, 303d corresponding to each of the preset characters “A”, “B”, “C”, “D” respectively. The curve calculating module 434 calculates a preset close-loop scope 305a, 305b, 305c, 305d corresponding to each of the preset characters “A”, “B”, “C”, “D” according to the touched boundaries respectively. Wherein, the preset close-loop scopes 305a, 305b, 305c, 305d are taken as the touched scope corresponding to the preset characters “A”, “B”, “C”, “D” respectively. Each of the preset close-loop scopes 305a, 305b, 305c, 305d corresponding to each of the preset characters “A”, “B”, “C”, “D” includes several curves, and each of the curves thereof touches at least one of the touched boundaries 304a, 304b, 304c, 304d at just one point. The curves thereof may be Bazier Curves or other types of curves, which touch the corresponding touched boundaries 304a, 304b, 304c, 304d at just one point.

Then, after the preset close-loop scopes 305a, 305b, 305c, 305d are calculated, the software keyboard 301 can be touched for input. Besides, the touch screen 300 displays the same software keyboard 301 as shown in FIG. 2A, which can avoid that users touch different position for character input as the displayed software keyboard 301 changes. Besides, the distance between the preset base center point 303a, 303b, 303c, 303d and the corresponding preset close-loop scope 305a, 305b, 305c, 305d is closer than the distance between the preset base center point 303a, 303b, 303c, 303d and the corresponding touched boundaries 304a, 304b, 304c, 304d, which can provide more trustworthy for touch input.

Then, users can touch the touch screen 300 for input. Hence, the output module 435 identifies and outputs a corresponding character, whose corresponding close-loop scope is occupied by the second touched position, when a second touched position on the touch screen is received. Wherein, the corresponding close-loop scope is one of the preset close-loop scopes 305a, 305b, 305c, 305d. In one embodiment of this invention, if the output module 435 receives a second touch position 306 from the touch screen 300, the output module 435 identifies and outputs a corresponding character “A”, the second touched position 306 is in the close-loop scope 305a corresponding to which.

Besides, if the second touched position is not in any of the preset close-loop scopes 305a, 305b, 305c, 305d, a nearest character, a nearest base center point corresponding to which is nearest to the second touched position among the preset base center points 303a, 303b, 303c, 303d, is output. Hence, the output module 435 may include a boundary determiner 435a. The boundary determiner 435a determines whether the second touched position is in one of the preset close-loop scopes 305a, 305b, 305c, 305d or not. If the second touched position is not in one of the preset close-loop scopes, the output module 435 outputs a nearest character, a nearest base center point corresponding to which is nearest to the second touched position among the preset base center points. For example, if a second touched position 307 is received from the touch screen 300, the output module 435 outputs the nearest character “A”, a nearest base center point 303a corresponding to which is nearest to the second touched position 307 among the preset base center points 303a, 303b, 303c, 303d, is output. Hence, if the touched position is not positioned in any of the preset close-loop scopes 305a, 305b, 305c, 305d, corresponding characters can still be output.

Besides, the boundary calculating module 433 may calculate touched boundaries according to offset along different axis (such as x-axis, y-axis, z-axis or other types of axes) for calculating more precisely. Hence, the offset calculating module 432 may include a first offset calculator 432a and a second offset calculator 432b, and the boundary calculating module 433 may include a first deviated point calculator 433a, a second deviated point calculator 433b and a median calculator 433c. The first offset calculator 432a calculates at least one first-axis distance from the preset base center point 303a, 303b, 303c, 303d to the at least one first touched position corresponding to each of the preset characters “A”, “B”, “C”, “D” along the first axis respectively. The first offset calculator 432a calculates average of the at least one first-axis distance to be taken as the first axis offset corresponding to each of the preset characters “A”, “B”, “C”, “D” respectively. Besides, if the at least one first-axis distance is less than a threshold, the value of the at least one first-axis distance can be assigned to zero to reduce the value of the first axis offset. The boundary calculating module 433 may calculate a first deviated boundary according to the first axis offset and the preset base center point 303a, 303b, 303c, 303d corresponding to each of the preset characters “A”, “B”, “C”, “D”. Wherein, the first deviated boundary may be taken as the at least one touched boundary between each of the preset characters “A”, “B”, “C”, “D” and the neighboring characters thereof. In detail, the first deviated point calculator 433a of the boundary calculating module 433 may add the first axis offset to value of the preset base center point 303a, 303b, 303c, 303d along the first axis corresponding to each of the preset characters “A”, “B”, “C”, “D” to be taken as a first deviated center point corresponding to each of the preset characters “A”, “B”, “C”, “D”. Then, the median calculator 433c may calculate a first median, which is taken as the first deviated boundary, between each of the first deviated center point corresponding to each of the preset characters “A”, “B”, “C”, “D” and the first deviated center point corresponding to the neighboring characters thereof.

The second offset calculator 432b calculates at least one second-axis distance from the preset base center point 303a, 303b, 303c, 303d to the at least one first touched position corresponding to each of the preset characters “A”, “B”, “C”, “D” along the second axis respectively. The second offset calculator 432b calculates average of the at least one second-axis distance to be taken as the second axis offset corresponding to each of the preset characters “A”, “B”, “C”, “D” respectively. Besides, if the at least one second-axis distance is less than a threshold, the value of the at least one second-axis distance can be assigned to zero to reduce the value of the second axis offset. The boundary calculating module 433 may calculate a second deviated boundary according to the second axis offset and the preset base center point 303a, 303b, 303c, 303d corresponding to each of the preset characters “A”, “B”, “C”, “D”. Wherein, the second deviated boundary may be taken as the at least one touched boundary between each of the preset characters “A”, “B”, “C”, “D” and the neighboring characters thereof. In detail, the second deviated point calculator 433b of the boundary calculating module 433 may add the second axis offset to value of the preset base center point 303a, 303b, 303c, 303d along the second axis corresponding to each of the preset characters “A”, “B”, “C”, “D” to be taken as a second deviated center point corresponding to each of the preset characters “A”, “B”, “C”, “D”. Then, the median calculator 433c may calculate a second median, which is taken as the second deviated boundary, between each of the second deviated center point corresponding to each of the preset characters “A”, “B”, “C”, “D” and the second deviated center point corresponding to the neighboring characters thereof.

Above all, since the distance between the preset base center point and the corresponding preset close-loop scope is closer, trustworthy can be provided for touch input. Besides, the touch screen displays the same software keyboard after the touch boundaries (the preset close-loop scopes) calculated, which can avoid that users touch different position for character input as the displayed software keyboard changes.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for adjusting touch positions of software keyboard applying to an electrical device with a touch screen, wherein the method for adjusting touch positions of software keyboard comprises:
displaying a software keyboard on the touch screen, wherein the software keyboard comprises a plurality of keys, a plurality of displayed boundaries are displayed among the keys, each of the keys corresponds to a preset character respectively, each of the preset characters corresponds to a preset base center point on the touch screen respectively;
displaying the preset characters respectively to receive at least one first touched position corresponding to each of the preset characters on the touch screen;
calculating a touched offset corresponding to each of the preset characters according to the at least one first touched position corresponding to each of the preset characters respectively;
calculating at least one touched boundary among each of the preset characters and the neighboring characters thereof according to the touched offset and the preset base center point corresponding to each of the preset characters respectively;
calculating a preset close-loop scope corresponding to each of the preset characters according to the touched boundaries respectively;
receiving a second touched position on the touch screen;
identifying a corresponding character, whose corresponding close-loop scope is occupied by the second touched position; and
outputting the corresponding character.

2. The method for adjusting touch positions of software keyboard of claim 1 further comprising:
determining whether the second touched position is in one of the preset close-loop scopes or not; and
if the second touched position is not in one of the preset close-loop scopes, outputting a nearest character, a nearest base center point corresponding to which is nearest to the second touched position among the preset base center points.

3. The method for adjusting touch positions of software keyboard of claim 1, wherein each of the touched offset comprises a first axis offset and a second axis offset, the method for adjusting touch positions of software keyboard further comprises:
calculating at least one first-axis distance from the preset base center point to the at least one first touched position corresponding to each of the preset characters along the first axis respectively, and calculating average of the at least one first-axis distance to be taken as the first axis offset corresponding to each of the preset characters respectively;
calculating at least one second-axis distance from the preset base center point to the at least one first touched position corresponding to each of the preset characters along the second axis respectively, and calculating average of the at least one second-axis distance to be taken as the second axis offset corresponding to each of the preset characters respectively;
calculating a first deviated boundary according to the first axis offset and the preset base center point corresponding to each of the preset characters; and
calculating a second deviated boundary according to the second axis offset and the preset base center point corresponding to each of the preset characters, wherein the at least one touched boundary among each of the preset characters and the neighboring characters thereof comprises the first deviated boundary and the second deviated boundary corresponding to each of the preset characters.

4. The method for adjusting touch positions of software keyboard of claim 3 further comprising:
adding the first axis offset to value of the preset base center point corresponding to each of the preset characters along the first axis to obtain a first deviated center point corresponding to each of the preset characters;
adding the second axis offset to value of the preset base center point corresponding to each of the preset characters along the second axis to obtain a second deviated center point corresponding to each of the preset characters;
calculating a first median between each of the first deviated center point corresponding to each of the preset characters and the first deviated center point corresponding to the neighboring characters thereof; and
calculating a second median between each of the second deviated center point corresponding to each of the preset characters and the second deviated center point corresponding to the neighboring characters thereof, wherein the at least one touched boundary between each of the preset characters and the neighboring characters thereof comprises the first median and the second median.

5. The method for adjusting touch positions of software keyboard of claim 1 further comprising:
determining whether there is at least one deviated touched position, distance from which to the corresponding preset base center point is more than an offset limit, among the at least one first touched position corresponding to each of the preset characters or not; and
if there is the at least one deviated touched position, removing the deviated touched position before calculating the touched offset.

6. The method for adjusting touch positions of software keyboard of claim 1, wherein each of the preset close-loop scopes corresponding to each of the preset characters comprises a plurality of Bazier Curves.

7. The method for adjusting touch positions of software keyboard of claim 1, wherein each of the preset close-loop scopes corresponding to each of the preset characters comprises a plurality of curves, each of the curves touches at least one of the touched boundaries at just one point.

8. A non-transitory computer readable storage medium with a computer program to execute a method for adjusting touch positions of software keyboard applying to an electrical device with a touch screen, wherein the method for adjusting touch positions of software keyboard comprises:
displaying a software keyboard on the touch screen, wherein the software keyboard comprises a plurality of keys, a plurality of displayed boundary are displayed among the keys, each of the keys corresponding to a preset character respectively, each of the preset characters corresponds to a preset base center point on the touch screen respectively;
displaying the preset characters respectively to receive at least one first touched position corresponding to each of the preset characters on the touch screen;
calculating a touched offset corresponding to each of the preset characters according to the at least one first touched position corresponding to each of the preset characters respectively;
calculating at least one touched boundary among each of the preset characters and the neighboring characters thereof according to the touched offset and the preset base center point corresponding to each of the preset characters respectively;
calculating a preset close-loop scope corresponding to each of the preset characters according to the touched boundaries respectively;
receiving a second touched position on the touch screen;
identifying a corresponding character, whose corresponding close-loop scope is occupied by the second touched position; and
outputting the corresponding character.

9. A touch screen electrical device comprising:
a touch screen for displaying a software keyboard, wherein the software keyboard comprises a plurality of keys, a plurality of displayed boundaries are displayed among the keys;
a storage unit for storing a preset character corresponding to each of the keys respectively and for storing a preset base center point on the touch screen corresponding to each of the preset characters respectively; and
a processing unit electrically connected to the touch screen and the storage unit, wherein the processing unit comprises:
a boundary setting module for displaying the preset characters respectively to receive at least one first touched position corresponding to each of the preset characters on the touch screen;
an offset calculating module for calculating a touched offset corresponding to each of the preset characters according to the at least one first touched position corresponding to each of the preset characters respectively;
a boundary calculating module for calculating at least one touched boundary among each of the preset characters and the neighboring characters thereof according to the touched offset and the preset base center point corresponding to each of the preset characters respectively;
a curve calculating module for calculating a preset close-loop scope corresponding to each of the preset characters according to the touched boundaries respectively; and
an output module for identifying and outputting a corresponding character, whose corresponding close-loop scope is occupied by the second touched position, when a second touched position on the touch screen is received, wherein the corresponding close-loop scope is one of the preset close-loop scopes.

10. The touch screen electrical device of claim 9, wherein the output module further comprises:
a boundary determiner for determining whether the second touched position is in one of the preset close-loop scopes or not,
wherein if the second touched position is not in one of the preset close-loop scopes, the output module outputs a nearest character, a nearest base center point corresponding to which is nearest to the second touched position among the preset base center points.

11. The touch screen electrical device of claim 9, wherein number of the at least one touched boundary between each of the preset characters and the neighboring characters thereof is more than one, each of the touched offset comprises a first axis offset and a second axis offset, the offset calculating module comprises:
a first offset calculator for calculating at least one first-axis distance from the preset base center point to the at least one first touched position corresponding to each of the preset characters along the first axis respectively, and calculating average of the at least one first-axis distance to be taken as the first axis offset corresponding to each of the preset characters respectively; and
a second offset calculator for calculating at least one second-axis distance from the preset base center point to the at least one first touched position corresponding to each of the preset characters along the second axis respectively, and calculating average of the at least one second-axis distance to be taken as the second axis offset corresponding to each of the preset characters respectively,
wherein the boundary calculating module calculates a first deviated boundary according to the first axis offset and the preset base center point corresponding to each of the preset characters,
wherein the boundary calculating module calculates a second deviated boundary according to the second axis offset and the preset base center point corresponding to each of the preset characters,
wherein the touched boundaries between each of the preset characters and the neighboring characters thereof comprises the first deviated boundary and the second deviated boundary corresponding to each of the preset characters.

12. The touch screen electrical device of claim 11, wherein the boundary calculating module comprises:
a first deviated point calculator for adding the first axis offset to value of the preset base center point corresponding to each of the preset characters along the first axis to obtain a first deviated center point corresponding to each of the preset characters;
a second deviated point calculator for adding the second axis offset to value of the preset base center point corresponding to each of the preset characters along the second axis to obtain a second deviated center point corresponding to each of the preset characters; and
a median calculator for calculating a first median between each of the first deviated center point corresponding to each of the preset characters and the first deviated center point corresponding to the neighboring characters thereof, and for calculating a second median between each of the second deviated center point corresponding to each of the preset characters and the second deviated center point corresponding to the neighboring characters thereof,
wherein the at least one touched boundary between each of the preset characters and the neighboring characters thereof comprises the first median and the second median.

13. The touch screen electrical device of claim 9, wherein the offset calculating module comprises:
a deviation determiner for determining whether there is at least one deviated touched position, distance from which to the corresponding preset base center point is more than an offset limit, among the at least one first touched position corresponding to each of the preset characters or not; and
if there is the at least one deviated touched position, the offset calculating module removes the deviated touched position before calculating the touched offset.
